(19) United States
(12) Patent Application Publication
(10) Pub. No.: US 2011/0174564 A1
(43) Pub. Date: Jul. 21, 2011

(54) ELECTRIC POWER GENERATION SYSTEM FOR ELECTRIC VEHICLES

(76) Inventor: Shin nam Soo, Jung-gu Daejeon (KR)

(21) Appl. No.: 13/009,391

(22) Filed: Jan. 19, 2011

(30) Foreign Application Priority Data
Jan. 20, 2010 (KR) 10-2010-0005309

(51) Int. Cl. B60K 25/10; F16H 9/26

(52) U.S. Cl. 180/165; 475/149

(57) ABSTRACT

A power generation control system of an electric vehicle is disclosed. The power generation control system of an electric vehicle is characterized in that an elastic recovery force of a spring is converted into a rotational energy via a spring power generation apparatus, and the converted rotational energy is accelerated for thereby driving a vehicle generator and generating electric power, and when the spring is over loosened, the auto winding operation of a spring is performed by means of a spring winding motor with the help of a control of the control unit, and when the battery is over charged by means of the power generation process, the operation of the spring power generation apparatus is stopped.

### CROSS-REFERENCE TO RELATED APPLICATION

This application claims priority to Korean Patent Application No. 2010-0005309 filed on Jan. 20, 2010, the contents of which are herein incorporated by reference in their entirety.

### BACKGROUND

1. Technical Field

Embodiments of the present invention relate to an electric power generation system for an electric vehicle, which is capable of independent power generation.

2. Discussion of the Related Art

Electric vehicles which use electrical energy as a driving source are environment-friendly, but may not be suited for long-distance driving due to a lack of recharging stations, a limited capacity of a battery, etc.

Accordingly, the electric vehicles have been used for limited purposes.

Therefore, there is a need for a power generation control system for an electric vehicle, which is capable of independent power generation.

### SUMMARY

Embodiments of the present invention provide a power generation control system for an electric vehicle, which may perform a manual winding operation of a spring by using an external force and an automatic winding operation of the spring by using a controller, a detection sensor, and a spring winding motor, and may prevent an over charging operation of a battery.

According to an embodiment of the present invention, there is provided a power generation control system for an electric vehicle, comprising a spring power generation unit which converts an elastic recovery force of a spring into rotational motion, accelerates the rotational motion, and transfers the accelerated rotational motion to a vehicle generator to generate electric power, a battery which stores the electric power generated by the vehicle generator, an overcharge detection unit which detects an excess charge of the battery that is greater than a predetermined amount, a detection sensor which detects a loose tension of the spring that is less than a predetermined amount, a spring winding motor which provides a driving force to a main driving shaft cooperating with the spring, a braking unit which restricts movement of the main driving shaft, and a control unit, wherein the control unit provides power to the spring winding motor for a predetermined time period when the detection sensor detects the loose tension of the spring to perform a winding operation of the spring; wherein, when the overcharge detection unit detects the excess charge of the battery, the control unit enables a winding operation of the spring and operates the braking unit to stop a power generation operation of the spring power generation unit; and wherein, when the battery is released from the excess charge, the control unit ceases the operation of the braking unit.

According to an embodiment, the spring power generation unit includes, between the main driving shaft and the vehicle generator, a first revolution accelerating unit which receives a main driving force from the main driving shaft and outputs a first driving force and a first accelerated revolution speed, a second revolution accelerating unit which receives the first driving force from the first revolution accelerating unit and outputs a second driving force and a second accelerated revolution speed, and a third revolution accelerating unit which receives the second driving force from the second revolution accelerating unit and outputs a third driving force and a third accelerated revolution speed to the vehicle generator to operate the vehicle generator.

According to an embodiment, the power generation control system further comprises a revolution decelerating unit which is disposed between the main driving shaft and the spring winding motor, receives a spring driving force from the spring winding motor, and outputs a driving force to the main driving shaft to rotate the main driving shaft in an opposite direction from an original direction of rotation of the main driving shaft.

According to an embodiment, the power generation control system further comprises a manual handle which is connected with the main driving shaft to apply an external force to the main driving shaft, wherein when the external force is applied to the main driving shaft, the main driving shaft rotates in an opposite direction from an original direction of rotation of the main driving shaft.

According to an embodiment, the power generation control system further comprises a fourth revolution accelerating unit which is disposed between the main driving shaft and the manual handle to output a force which accelerates a rotation velocity of the main driving shaft.

According to an embodiment, the revolution decelerating unit comprises a first driving module that includes a first driving shaft and a solar gear, wherein an end of the first driving shaft is integrally connected to a center of the solar gear, a second driving module that includes a second driving shaft and a pinion, wherein an end of the second driving shaft is integrally connected to a center of the pinion, a gear sequence which is identical in number to the solar gear and the pinion and is engaged with the solar gear and the pinion, wherein the gear sequence includes first and second gears and a support shaft that passes through central portions of the first and second gears, and a support unit through which the first and second driving shafts rotatably pass, wherein the support shaft is rotatably supported by the support unit, wherein a through hole is formed to pass through the first driving shaft, the solar gear, the pinion, and the second driving shaft, wherein the main driving shaft passes through the through hole.

According to an embodiment, a latch groove is provided at an outer circumferential portion of the main driving shaft and includes a sliding portion and an engaging portion, and wherein the revolution decelerating unit includes a latch module at an outer circumferential portion of the second driving shaft, wherein the latch module includes

a support frame that rotates together with the second driving shaft, a latch unit that is provided on an upper side of the support frame, and a latch casing that includes a spring therein to elastically and downwardly support the latch unit, wherein a lower portion of the latch unit has a shape corresponding to a shape of the latch groove, and wherein a latch move hole is formed at the second driving shaft, wherein the latch unit passes through the latch move hole to be guided to the latch groove.

According to an embodiment, a one-way bearing is disposed on an outer circumferential portion of the first driving shaft of the revolution decelerating unit and rotates in a direction of the main driving shaft but not in an opposite direction, and wherein a first pulley is disposed on an outer circumferential portion of the one-way bearing and rotates together with the one-way bearing, and the first pulley is connected with a second pulley disposed on a driving shaft of the spring winding motor.

According to an embodiment, each of the first revolution accelerating unit, the second revolution accelerating unit, and the third revolution accelerating unit comprises a first driving module that includes a first driving shaft and a solar gear, wherein an end of the first driving shaft is integrally connected to a center of the solar gear, a second driving module that includes a second driving shaft and a pinion, wherein an end of the second driving shaft is integrally connected to a center of the pinion, at least one gear sequence, wherein the number of gear sequences is as the same as the number of solar gears and pinions and wherein each gear sequence is engaged with the solar gear and the pinion, and includes first and second gears and a support shaft that passes through central portions of the first and second gears, and a support unit through which the first and second driving shafts rotatably pass, wherein the support shaft is rotatably supported by the support unit, wherein a through hole is formed to pass through the first driving shaft, the solar gear, the pinion, and the second driving shaft, wherein a shaft passes through the through hole.

According to an embodiment, a one-way bearing is disposed on an outer circumferential portion of the main driving shaft between the main driving shaft and a pulley and rotates in a direction of the main driving shaft but not in an opposite direction, and the pulley is disposed on an outer circumferential portion of the one-way bearing to rotate along with the one-way bearing.

According to an embodiment, the detection sensor includes contact points which are spaced by a predetermined distance apart from an outermost side of a plate spring belonging to the spring and the outermost side, wherein the contact points are pressed to contact each other by the outermost side of the plate spring when the tension of the spring is less than the predetermined amount.

According to an embodiment, the main driving shaft is equipped with a braking disk, wherein the braking unit exerts pressure on the braking disk.

### BRIEF DESCRIPTION OF THE DRAWINGS

The embodiments of the present invention are better understood with reference to the accompanying drawings which are provided to illustrate, but not limit the present invention, wherein;

FIG. 1 is a view schematically illustrating a power generation control system for an electric vehicle according to an embodiment of the present invention;

FIG. 2 is a flowchart illustrating a control operation of a power generation control system for an electric vehicle according to an embodiment of the present invention;

FIG. 3 is a view schematically illustrating the spring power generation unit shown in FIG. 1;

FIG. 4 is an exploded perspective view illustrating a revolution deceleration unit of a major portion I of FIG. 3;

FIG. 5 is a cross-sectional view taken along line A-A′ of FIG. 3, wherein some elements have been omitted from the construction of FIG. 4;

FIG. 6 is a cross-sectional view taken along line B-B′ of FIG. 5;

FIG. 7 is a cross-sectional view taken along A-A′ of FIG. 4, wherein the elements shown in FIG. 4 have been assembled;

FIG. 8 is a cross-sectional view taken along C-C′ of FIG. 7;

FIGS. 9 and 10 are cross-sectional views taken along line D-D′ of FIG. 7, which show an operation state of a latch module;

FIG. 11 is a cross-sectional view taken along line E-E′ of FIG. 3;

FIG. 12 is a cross-sectional view taken along line F-F′ of FIG. 3;

FIG. 13 is a cross-sectional view taken along line G-G′ of FIG. 3; and

FIG. 14 is a cross-sectional view taken along line H-H′ of FIG. 3.

### DESCRIPTION OF THE EMBODIMENTS

Exemplary embodiments of the present invention will be described with reference to the accompanying drawings, wherein the same reference numerals may be used to denote the same or substantially the same elements throughout the drawings and the specification.

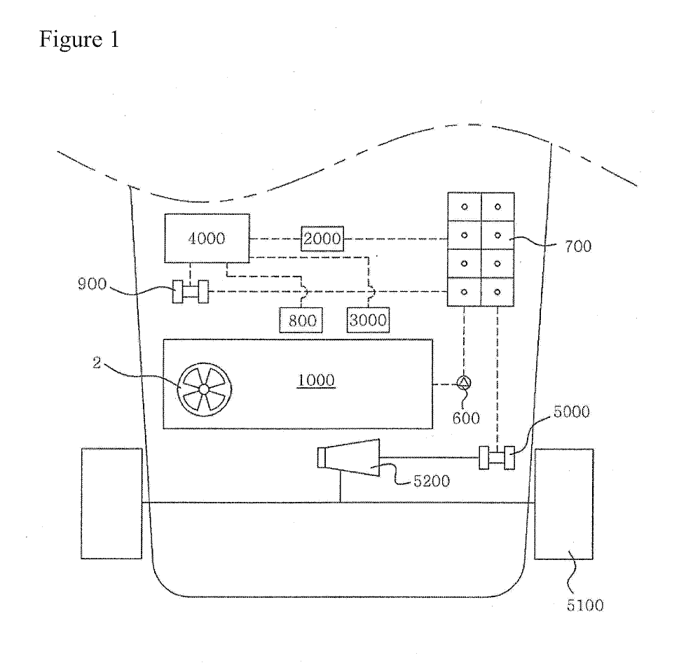

FIG. 1 is a view schematically illustrating a power generation control system for an electric vehicle according to an embodiment of the present invention.

As shown in FIG. 1, the power generation control system for an electric vehicle comprises a spring power generation unit 1000, an overcharge detection unit 2000, a braking unit 3000, a detection sensor 800, a battery 700, and a spring winding motor 900.

In an electric construction, the spring power generation unit 1000 is electrically connected with a vehicle generator 600, and the battery 700 is connected with the spring winding motor 900, the overcharge detection unit 2000, the detection sensor 800, and the braking unit 3000, respectively, which are electrically connected with the control unit 4000. The battery 700 is also electrically connected with a driving motor 5000.

In a mechanical construction, the driving motor 5000 is connected with a transmission 5200, and the transmission 5200 is connected with a driving wheel 5100.

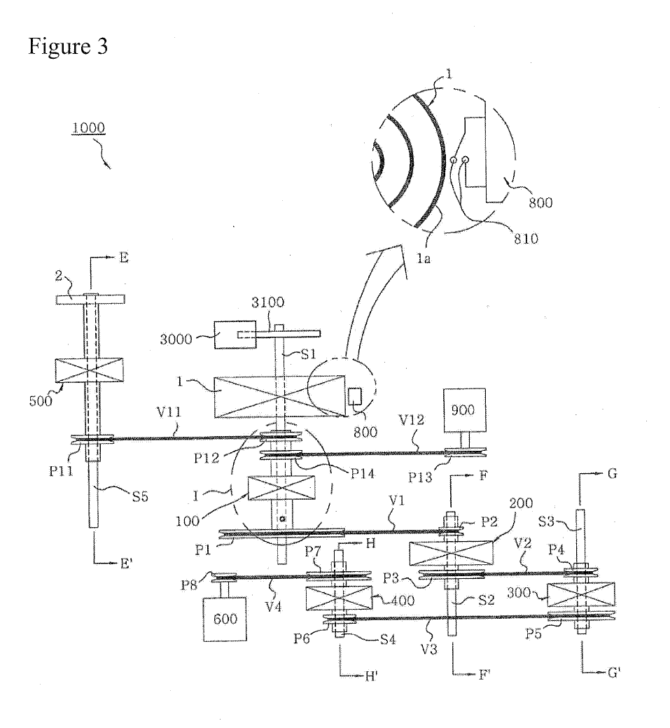

The spring power generation unit 1000 will be described in more detail with reference to FIGS. 3 through 14.

FIG. 3 is a front view from a front side of the vehicle schematically illustrating the spring power generation unit 1000 of FIG. 1.

As shown in FIG. 3, the spring power generation unit 1000 comprises a revolution deceleration unit 100, which is axially disposed on and operably coupled to a main driving shaft S1; a plurality of first through fourth revolution accelerating units 200, 300, 400, and 500, which are axially disposed on and operably coupled to a plurality of shafts S2, S3, S4, and S5, respectively; and a spring 1 connected with the main driving shaft S1. The revolution decelerating unit 100 is connected with the fourth revolution accelerating unit 500. A manual handle 2 is connected to the fourth revolution accelerating unit 500.

The revolution decelerating unit 100 is connected with the spring winding motor 900. The third revolution accelerating unit 400 is connected with the vehicle generator 600. The vehicle generator 600 is electrically connected with the battery 700. The detection sensor 800 is positioned adjacent to the spring 1. When detecting an over-loosened state of the spring 1, the detection sensor 800 transmits a certain signal to the control unit 4000.

As shown in FIG. 3, the detection sensor 800 has contact points 810 which are spaced by a predetermined distance apart from an outermost side 1a of a plate spring which is a part of the spring 1. The detection sensor 800 including the contact points 810 is positioned opposite to the outermost side 1a. The contact points 810 are pressed to contact each other by the outermost side 1a of the plate spring when the tension of the spring 1 is loosened beyond a predetermined level (“over loosened”), thereby transmitting a contact signal to the control unit 4000. According to an embodiment, the control unit 4000 supplies electric energy stored in the battery 700 to the spring winding motor 900 for a certain time period, so that the spring winding motor 900 can operate for a certain time period.

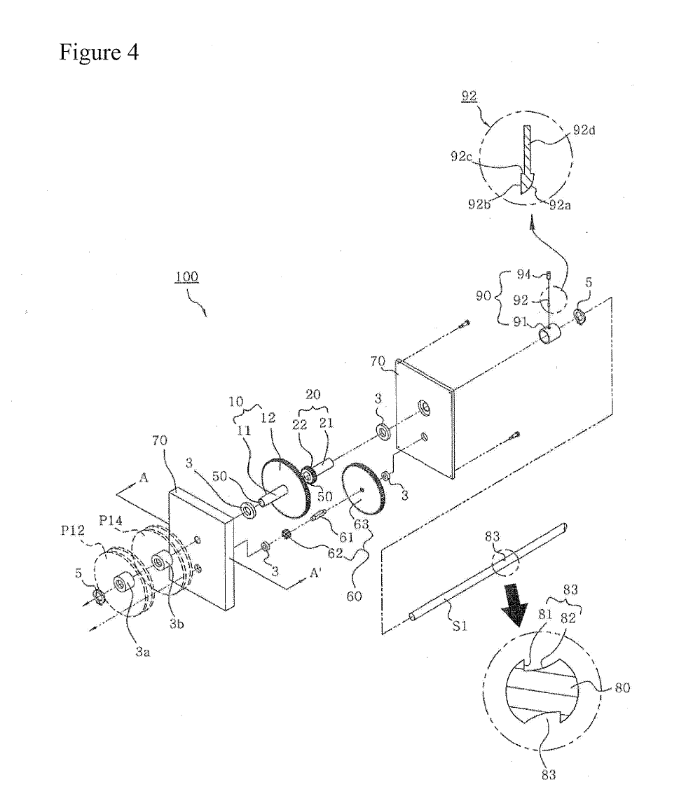

The main driving shaft S1 is equipped with a braking disk 3100, and the braking unit 3000 is implemented as a conventional disk braking unit which exerts pressure on the braking disk 3100. With reference to FIGS. 4 through 10, the revolution decelerating unit 100 which is an element of the spring power generation unit 1000 will be described.

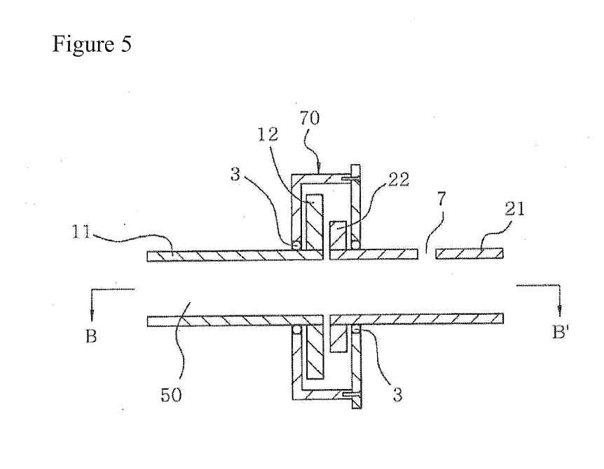

FIG. 4 is an exploded perspective view illustrating portion I of FIG. 3 including the revolution deceleration unit 100. FIG. 5 is a cross-sectional view taken along line A-A′ of FIG. 3, wherein some elements are omitted from the construction of Figure.

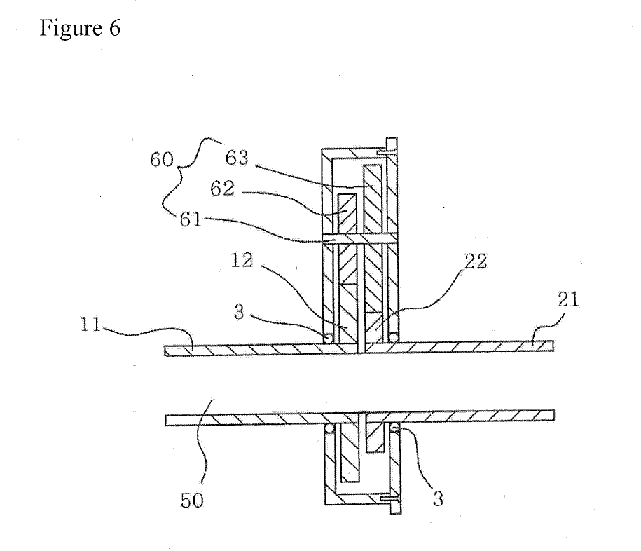

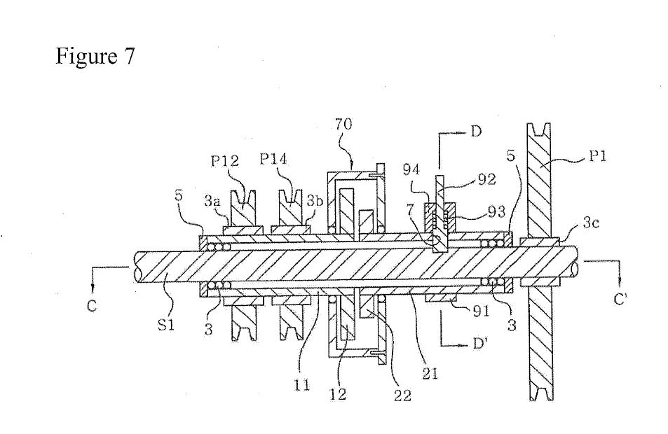

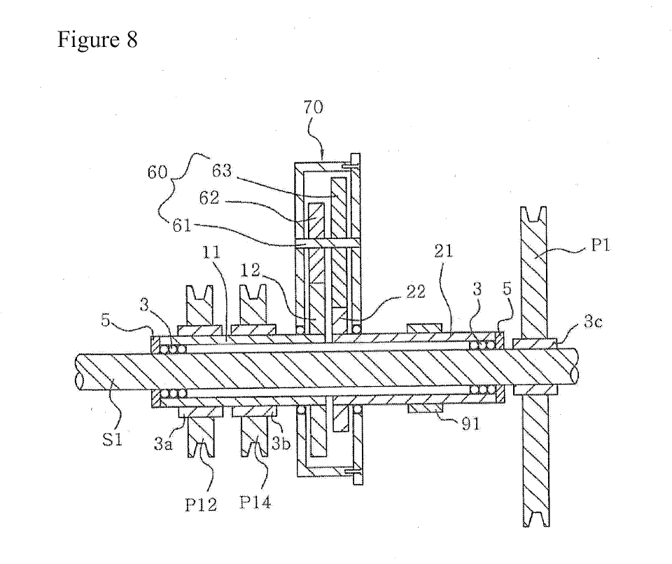

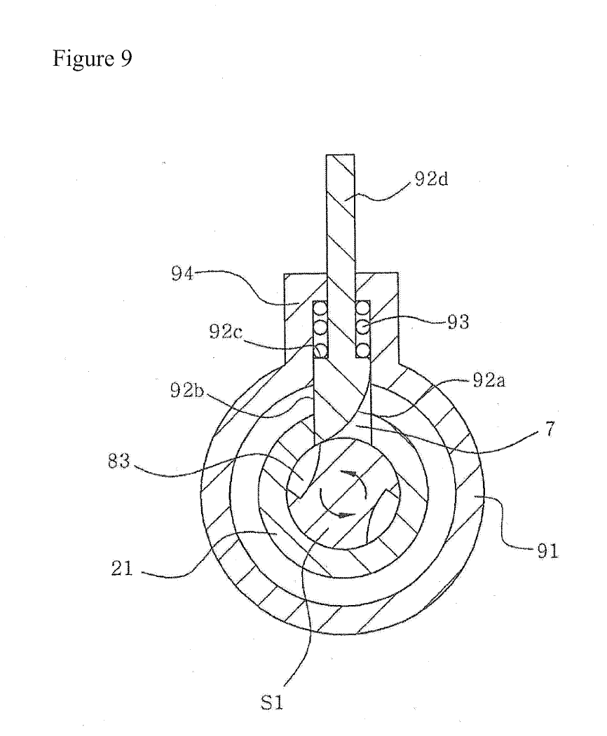

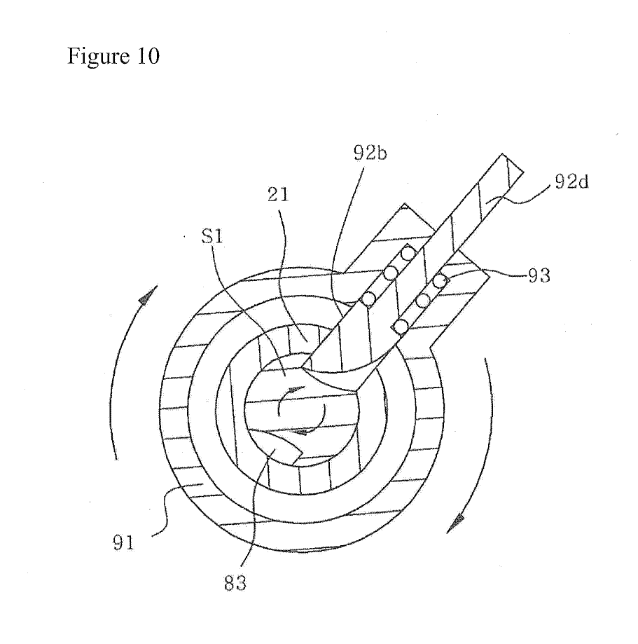

FIG. 6 is a cross-sectional view taken along line B-B′ of FIG. 5. FIG. 7 is a cross-sectional view taken along A-A′ of FIG. 4, wherein the elements shown in FIG. 4 have been assembled. FIG. 8 is a cross-sectional view taken along C-C′ of FIG. 7. FIGS. 9 and 10 are cross-sectional views of line D-D′ of FIG. 7, which show an operation state of a latch module 90.

As shown in FIGS. 4 through 10, the revolution decelerating unit 100 comprises first and second driving modules 10 and 20, a gear sequence 60, and a support unit 70. The first driving module 10 includes a first driving shaft 11 and a solar gear 12, wherein an end of the first driving shaft 11 is integrally connected to a center of the solar gear 12, and the second driving module 20 includes a second driving shaft 21 and a pinion 22, wherein an end of the second driving shaft 21 is integrally connected to a center of the pinion 22. A through hole 50 is formed to pass through the first driving shaft 11, the solar gear 12, the pinion 22, and the second driving shaft 21 as shown in FIGS. 4 through 6.

The number of the gear sequence(s) 60 is the same as the number of the solar gear(s) 12 and the number of the pinion(s) 22.

The gear sequence 60 is engaged with the solar gear 12 and the pinion 22. The gear sequence 60 includes a support shaft 61, and gears 62 and 63 that are axially connected to the support shaft 61 at their centers, as shown in FIGS. 6 and 8. The gear 63 having a larger pitch among the gears 62 and 63 is in meshing engagement with the pinion 22 to cooperate with the second driving module 20, and the gear 62 having a smaller pitch is in meshing engagement with the solar gear 12, as shown in FIGS. 6 and 8. The gear sequence 60 is configured to cooperate with the first and second driving modules 10 and 20. When a driving force is applied to the first driving shaft 11, the second driving shaft 21 decelerates with its revolution being reduced as compared to the first driving shaft 11, and when a driving force is applied to the second driving shaft 21, the first driving shaft 11 accelerates with its revolution being increased as compared to the second driving shaft 21.

The first through fourth revolution accelerating units 200, 300, 400, and 500 have the same structure as that of the revolution decelerating unit 100. However, in the case of the revolution decelerating unit 100, a driving force is applied to the first driving shaft 11 and a decelerated revolution speed is outputted via the second driving force shaft 21, and in the case of the first through fourth revolution accelerating units 200, 300, 400, and 500, a driving force is applied to the second driving shaft 21 and an accelerated revolution speed is outputted via the first driving shaft 11. According to embodiments, the revolution decelerating unit 100 and the first through fourth revolution accelerating units 200, 300, 400, and 500 may function as a revolution decelerating unit, such as the revolution decelerating unit 100, which decelerates a revolution speed or a revolution accelerating unit, such as the first through fourth revolution accelerating units 200, 300, 400, and 500, which accelerates a revolution speed depending on where the driving force is inputted from and is outputted to.

The first and second driving shafts 11 and 21 pass through the support unit 70.

The support shaft 61 is rotatably supported by the support unit 70, as shown in FIGS. 6 and 8.

The revolution decelerating unit 100 is further provided with a latch module 90 at an outer circumferential portion of the second driving force shaft 21. A pair of latch grooves 83 that face each other are provided at an outer circumferential portion of the main driving force shaft S1. Each of the latch grooves 83 includes a sliding portion 81 and an engaging portion 82.

The latch module 90 is axially provided at an outer circumferential portion of the second driving shaft 21. The latch module 90 includes a support frame 91 which rotates together with the second driving shaft 21, a latch unit 92 that is provided on an upper side of the support frame 91, and a latch casing 94 that has a spring 93 therein to elastically support the latch unit 92 in the latch casing 94 in a downward direction. A lower portion of the latch unit 92 has a shape corresponding to that of the latch groove 83, as shown in FIG. 4. As shown in FIG. 4, the latch unit 92 includes a slope portion 92a with a slope identical or similar to that of the sliding unit 81, a cut-away surface 92b which extends vertically from an end of the slope portion 92a, an engaging shoulder 92c which is formed on upper sides of the cut-away surface 92b and the slope portion 92a, and a support rod 92d which is extended upwardly from an upper surface of the engaging shoulder 92c. The spring 93 is disposed between an inner upper surface of the latch casing 94 and the engaging shoulder 92c of the latch unit 92, so that the spring 93 exerts an elastic force of a certain level toward the latch groove 83 as shown in FIGS. 7, 9, and 10.

A latch move hole 7 is formed at the second driving shaft 21 of the revolution decelerating unit 100. The latch unit 92 passes through the latch move hole 7 to be guided into the latch groove 83 as shown in FIGS. 5 and 7.

As shown in FIG. 9, when the main driving shaft S1 rotates counterclockwise (in a leftward direction in FIG. 3) by an elastic recovery force of the spring 1, the slope portion 92a slides along the sliding portion 81 of the latch groove 83, so that only the main driving shaft S1 rotates counterclockwise, thereby generating electric power.

As shown in FIG. 10, when a driving force is applied to the first driving shaft 21 of the revolution decelerating unit 100 through the spring winding motor 900 or the manual handle 2, the second driving shaft 21 of the revolution decelerating unit 100 rotates clockwise (in a right direction in FIG. 3), and the cut-away surface 92b is engaged with the engaging portion 82 of the latch groove 83, so that the main driving shaft S1 rotates clockwise along with the second driving shaft 21 of the revolution decelerating unit 100. As a consequence, the recovery force of the spring 1 connected with the main driving shaft S1 is increased as a plate spring (not shown) included in the spring 1 is wound by the clockwise direction rotation.

Two one-way bearings 3a and 3b are provided on an outer circumferential portion of the first driving shaft 11 of the revolution decelerating unit 100, which rotate in a direction opposite to a driving direction of the spring winding motor 900 while not rotating in its opposite direction. Two pulleys P12 and P14 are provided on the one-way bearings 3a and 3b, respectively, and rotate together with the one-way bearings 3a and 2b, respectively.

The pulley P14 is connected via a driving force transfer belt V12 with a pulley P13 provided on a driving shaft of the spring winding motor 900, and the pulley P12 is connected via the driving force transfer belt V11 with a pulley P11 of the fourth revolution accelerating unit 500.

A pulley P1 is provided on an outer circumferential portion of the main driving shaft S1 to allow the main driving shaft S1 to transfer a driving force of a counterclockwise direction (in a leftward direction in FIG. 3) to the first revolution accelerating unit 200 by an elastic recovery force of the spring 1 as shown in FIG. 9. One-way bearing 3c is provided on an outer circumferential portion of the main driving shaft 51 between the driving shaft S1 and the pulley P1 and rotates in a direction which is opposite to a rotation direction of the main driving shaft S1. The pulley P1 is provided on an outer circumferential portion of the one-way bearing 3c to rotate along with the one-way bearing 3c as shown in FIGS. 7 and 8.

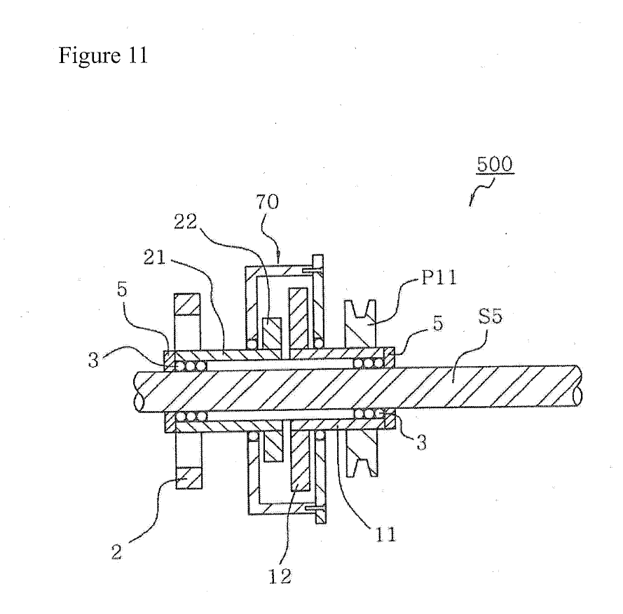

The first through fourth driving accelerating units 200, 300, 400, and 500 will be described in greater detail with reference to FIGS. 11 through 14.

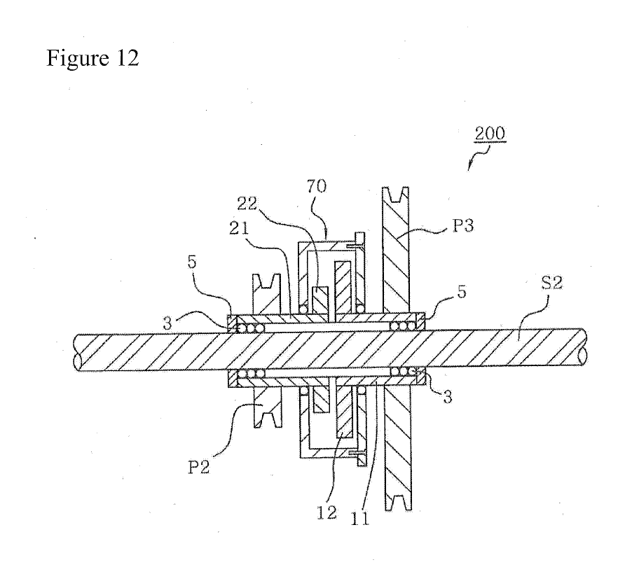

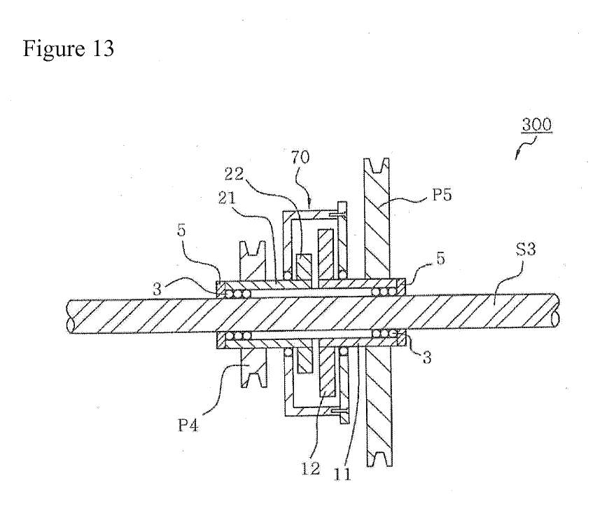

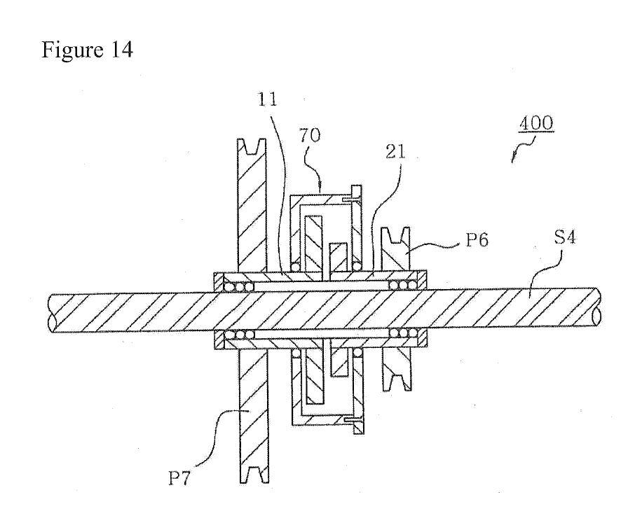

FIG. 11 is a cross sectional view taken along line E-E′ of FIG. 3, FIG. 12 is a cross sectional view taken along line F-F′ of FIG. 3, FIG. 13 is a cross sectional view taken along line G-G′ of FIG. 3, and FIG. 14 is a cross sectional view taken along line H-H′ of FIG. 3.

According to an embodiment, the first through fourth revolution accelerating units 200, 300, 400, and 500 may have the same construction as the revolution decelerating unit 100 with respect to the first and second driving modules 10 and 20, the gear sequence 60, and the support unit.

Referring to FIGS. 3 and 11, the fourth revolution accelerating unit 500 includes a pulley P11 axially disposed on an outer circumferential portion of a first driving shaft 11, and a manual handle 2 which is disposed on an outer circumferential portion of a second driving shaft 21. Since the shaft S5 passes through a through hole 50 of the fourth revolution accelerating unit 500, the fourth revolution accelerating unit 500 is supported by the shaft S5. Since bearings 3 are disposed in an interior of the through hole 50, the first and second driving shafts 11 and 21 of the fourth revolution accelerating unit 500 are freely rotated with respect to the shaft S5. The pulley P11 is connected with the pulley P12 installed on the first driving shaft 11 of the revolution decelerating unit 100 via the driving force transfer belt V11.

Referring to FIGS. 3 and 12, the pulleys P2 and P3 having different radiuses are respectively disposed on outer circumferential portions of second and first driving shafts 21 and 11 in the first revolution accelerating unit 200. The pulley P2 having a smaller radius is axially disposed on the second driving shaft 21 of the first revolution accelerating unit 200, and the pulley P3 having a larger radius is disposed on the first driving shaft 11 of the first revolution accelerating unit 200. The pulley P2 is connected with the pulley P1 disposed on the main driving shaft S1 via the driving force transfer belt V1, and the pulley P3 is connected with the second revolution accelerating unit 300. The shaft S2 passes through a through hole 50 of the first revolution accelerating unit 200, so that the first revolution accelerating unit 200 is supported by the shaft S2. Bearings 3 are disposed in the through hole 50, so that the first and second driving shafts 11 and 21 of the first revolution accelerating unit 200 can freely rotate with respect to the shaft S2.

Referring to FIGS. 3 and 13, the pulleys P4 and P5 having different radiuses are respectively disposed on outer circumferential portions of second and first driving shafts 21 and 11 in the second revolution accelerating unit 300. The pulley P4 having a smaller radius is axially disposed on the second driving shaft 21 of the second revolution accelerating unit 300, and the pulley P5 having a larger radius is disposed on the first driving shaft 11 of the second driving force accelerating unit 300. The pulley P4 is connected with the pulley P3 of the first revolution accelerating unit 200, and the pulley P5 having a larger radius is connected with the third revolution accelerating unit 400. The shaft S3 passes through a through hole 50 of the second revolution accelerating unit 300, so that the second revolution accelerating unit 300 is supported by the shaft S3. Since bearings 3 are provided in the through hole 50, the first and second driving shafts 11 and 21 can freely rotate with respect to the shaft S3.

Referring to FIGS. 3 and 14, the pulleys P6 and P7 having different radiuses are respectively disposed on outer circumferential portions of second and first driving shafts 21 and 11 in the third revolution accelerating unit 400. The pulley P6 having a smaller radius is axially disposed on the second driving shaft 21, and the pulley P7 having a larger radius is disposed on the first driving shaft 11. The pulley P6 is connected with the pulley P5 of the second revolution accelerating unit 300 via the driving force transfer belt V3, and the pulley P7 is connected with the pulley P8 disposed on the driving shaft of the vehicle generator 600. According to an embodiment, the pulley P8 of the vehicle generator 600 may be smaller than the pulley P7 of the third revolution accelerating unit 400. Since the shaft S4 passes through a through hole 50 of the third revolution accelerating unit 400, the third revolution accelerating unit 400 can be supported by the shaft S4. Since bearings 3 are disposed in the through hole 50, the first and second driving shafts 11 and 21 of the third revolution accelerating unit 400 can freely rotate with respect to the shaft S4.

The operations of a power generation control system for an electric vehicle according to an embodiment of the present invention will be described with reference to FIGS. 1 and 3.

Referring to FIG. 3, when a user rotates the manual handle 2 in a rightward direction, a revolution speed is accelerated by the fourth revolution accelerating unit 500, and the accelerated revolution speed is applied to the pulley P12 via the pulley P11 and the driving force transfer belt V11. A belt tensional force from the driving force transfer belt V11 is applied to the one-way bearing 3a connected with the pulley P12, so that the one-way bearing 3a exerts pressure on an outer circumferential portion of the first driving shaft 11 of the revolution decelerating unit 100, and as shown in FIG. 3, the first driving shaft 11 of the revolution decelerating unit 100 rotates in the right direction. As shown in FIG. 3, the second driving shaft 21 of the revolution decelerating unit 100 is more decelerated than the first driving shaft 11 of the revolution decelerating unit 100 and rotates in the same direction as the first driving shaft 11 of the revolution decelerating unit 100. As shown in FIG. 10, the main driving shaft S1 rotates clockwise (in the right direction in FIG. 3) by an engaging operation of the latch unit 92 and the latch groove 83. The spring 1 connected with the main driving shaft S1 performs a winding operation, and an elastic recovery force of the spring 1 is increased by the winding operation.

The one-way bearing 3b connected with the spring winding motor 900 is not applied with a belt tensional force since the spring winding motor 900 is not driven. The one-way bearing 3b connected with the spring winding motor 900 does not exert pressurize on an outer circumferential portion of the first driving shaft 11 of the revolution decelerating unit 100, so the elements 3b and 11 idle—for example, the first driving shaft 11 of the revolution decelerating unit 100 rotates in the right direction, and the one-way bearing 3b remains stationary.

One-way bearing 3c disposed on an outer circumferential portion of the main driving shaft S1 rolls along with the main driving shaft S1, so, as shown in FIG. 3, the main driving shaft S1 freely rotates with respect to the one-way bearing 3c, so that no driving force is transferred to the first revolution accelerating unit 200.

When the winding operation of the spring 1 is almost finished and the user stops applying the external force to the manual handle 2, the spring power generation unit 1000 starts generating power.

With reference to FIGS. 3 and 9, the electric power generation will be described. The main driving shaft S1 rotates in a left direction by an elastic recovery force of the spring 1, so, as shown in FIG. 9, the main driving shaft S1 freely rotates counterclockwise (in the left direction in FIG. 3) without restriction by the latch unit 92. The one-way bearing 3c disposed on the main driving shaft S1 cannot rotate in the left direction in FIG. 3, namely, in the rotation direction of the main driving shaft S1, but can rotate in the opposite direction. As a consequence, the bearing 3c exerts pressure on an outer portion of the main driving shaft S1 and thus rotates in the same speed and direction as the main driving shaft S1. The pulley P1 disposed on the outer portion of the bearing 3c rotates in the same direction as the bearing 3c, and a driving force of the main driving shaft S1 is transferred to the first revolution accelerating unit 200, thereby driving the first revolution accelerating unit 200.

The driving force of the main driving shaft S1 sequentially accelerates the first through third revolution accelerating units 200, 300, and 400, and the accelerated revolution speed is supplied to the vehicle generator 600 via the third revolution accelerating unit 400, so that the vehicle generator 600 generates power. The thusly generated power is stored in the battery 700.

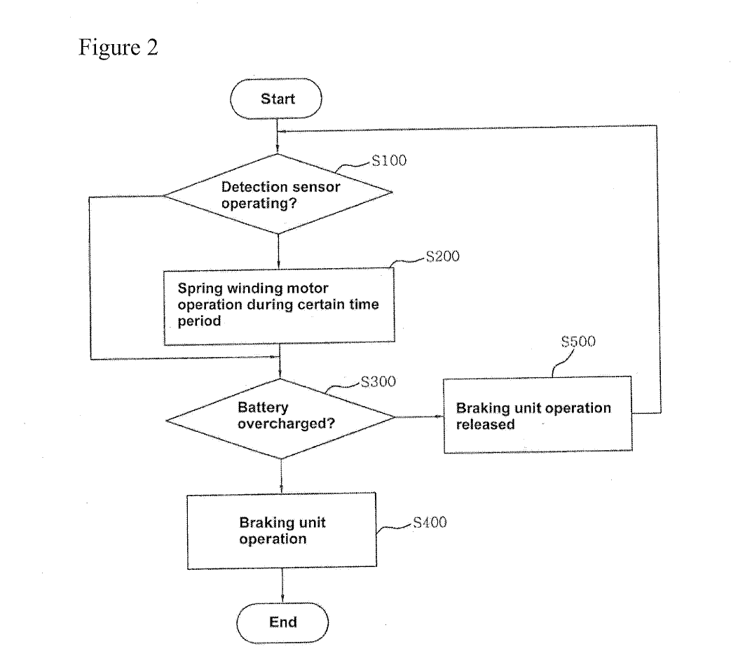

When the power generation gets started, the control unit 4000 performs a control operation as shown in FIG. 2, including an automatic winding operation of the spring and an operation of stopping the spring power generation unit 1000 for preventing overcharge of the battery.

FIG. 2 is a flowchart illustrating a control operation of a power generation control system for an electric vehicle according to an embodiment of the present invention.

Referring to FIG. 2, the control unit 4000 determines whether or not a contact signal is received by the detection sensor 800 to judge whether or not the spring 1 is beyond a predetermined level (“over loosened” (S100).

When it is determined that the spring 1 is over loosened in step S100, the control unit 4000 supplies electric energy stored in the battery 700 to the spring winding motor 900 for a certain time period, so that the spring winding motor 900 operates for a certain time period (S200). When it is not determined that the spring 1 is over loosened in step S100 or step S200 is finished, it is determined whether a s signal from the overcharge detection unit 2000, for example, an overcharge signal of the battery is received or not (S300).

When it is determined in step S300 that the overcharge signal of the battery is received, the control unit 4000 operates the braking unit 3000 (S400). The braking unit 3000 formed of a disk brake exerts pressure on the braking disk 3100 provided on the main driving shaft S1, so that the main driving shaft S1 no longer rotates. When it is determined in step S300 that the overcharge signal of the battery is not received, the operation of the braking unit 3000 is released (S500), and the routine returns to step S100.

As the power generation operation continues by the spring power generation unit 1000, the elastic recovery force of the spring 1 is exhausted, so that the control unit 4000 controls the automatic winding operation of the spring 1 via the detection sensor 800 and the spring winding motor 900. For example, in response to exhaustion of the elastic recovery force of the spring 1 through the detection sensor 800, the control unit 4000 allows the spring winding motor 900 to perform the automatic winding operation of the spring 1. As the above operation continues, when the battery 700 is over charged, the control unit 4000 operates the braking unit 3000 to stop the operation of the spring power generation unit 1000.

By the above operation, power for use in the vehicle can be generated, the life span of the battery can be extended, and mechanical fatigue and abrasion can be significantly reduced.

The automatic winding operation of the spring 1 will now be described. As the above power generation operation is performed for a certain time, the spring 1 is gradually unwound, and as a consequence, the outermost portion 1a of the plate spring exerts pressure on the contact points of the detection sensor 800, and the contact points 810 are brought in contact with each other as shown in FIG. 3. When the contact points 810 of the detection sensor 800 are brought in contact with each other, the detection sensor 800 transmits a contact signal to the control unit 4000. In response to the contact signal, the control unit 4000 supplies electric power stored in the battery 700 to the spring winding motor 900 for a certain time period to operate the spring winding motor 900 for a certain time period. Since the spring winding motor 900 rotates in the right direction in FIG. 3, a driving force is applied to the pulley P13 disposed on the driving shaft of the spring winding motor 900 and the pulley P14 of the first driving shaft 11 of the revolution decelerating unit 100 via the driving force transfer belt V12. As a result, a belt tensional force is applied to the one-way bearing 3b connected with the pulley P14 by an orbital movement of the driving force transfer bent V12, and the one-way bearing 3b exerts pressure on an outer surface of the first driving shaft 11 of the revolution decelerating unit 100, and as shown in FIG. 3, the first driving shaft 11 of the revolution decelerating unit 100 rotates in the right direction. The second driving shaft 21 of the revolution decelerating unit 100 is decelerated more than the first driving shaft 11 of the revolution decelerating unit 100 and rotates in the right direction like the first driving shaft 11 of the revolution decelerating unit 100. The main driving shaft S1 rotates clockwise, namely, in the right direction in FIG. 3 due to engagement of the latch unit 92 and the latch groove 83. The spring 1 connected with the main driving shaft S1 performs an automatic winding operation to recover the elastic recovery force. During the automatic winding operation, the power generation operation of the spring power generation unit 1000 stops.

The one-way bearing 3a connected with the fourth revolution accelerating unit 500 and the one-way bearing 3c disposed on the main driving shaft S1 remain idle on the first driving shaft 11 of the driving decelerating unit 100 and the main driving shaft S1, respectively. The first driving shaft 11 of the revolution decelerating unit 100 rotates in the right direction, but the one-way bearing 3a remains stationary. The main driving shaft S1 rotates in the right direction, but the one-way bearing 3c disposed on the outer diameter of the main driving shaft S1 rolls with the main driving shaft S1, so that the rotational force from the main driving shaft S1 is not transferred to the first revolution accelerating unit 200.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A power generation control system for an electric vehicle, comprising:
a spring power generation unit which converts an elastic recovery force of a spring into rotational motion, accelerates the rotational motion, and transfers the accelerated rotational motion to a vehicle generator to generate electric power;
a battery which stores the electric power generated by the vehicle generator;
an overcharge detection unit which detects an excess charge of the battery that is greater than a predetermined amount;
a detection sensor which detects a loose tension of the spring that is less than a predetermined amount;
a spring winding motor which provides a driving force to a main driving shaft cooperating with the spring;
a braking unit which restricts movement of the main driving shaft; and
a control unit, wherein the control unit provides power to the spring winding motor for a predetermined time period when the detection sensor detects the loose tension of the spring to perform a winding operation of the spring; wherein, when the overcharge detection unit detects the excess charge of the battery, the control unit enables a winding operation of the spring and operates the braking unit to stop a power generation operation of the spring power generation unit; and wherein, when the battery is released from the excess charge, the control unit ceases the operation of the braking unit.

2. The system of claim 1, wherein the spring power generation unit includes, between the main driving shaft and the vehicle generator,
a first revolution accelerating unit which receives a main driving force from the main driving shaft and outputs a first driving force and a first accelerated revolution speed;
a second revolution accelerating unit which receives the first driving force from the first revolution accelerating unit and outputs a second driving force and a second accelerated revolution speed; and
a third revolution accelerating unit which receives the second driving force from the second revolution accelerating unit and outputs a third driving force and a third accelerated revolution speed to the vehicle generator to operate the vehicle generator.

3. The system of claim 3, further comprising:
a revolution decelerating unit which is disposed between the main driving shaft and the spring winding motor, receives a spring driving force from the spring winding motor, and outputs a driving force to the main driving shaft to rotate the main driving shaft in an opposite direction from an original direction of rotation of the main driving shaft.

4. The system of claim 1, further comprising:
a manual handle which is connected with the main driving shaft to apply an external force to the main driving shaft, wherein when the external force is applied to the main driving shaft, the main driving shaft rotates in an opposite direction from an original direction of rotation of the main driving shaft.

5. The system of claim 4, further comprising:
a fourth revolution accelerating unit which is disposed between the main driving shaft and the manual handle to output a force which accelerates a rotation velocity of the main driving shaft.

6. The system of claim 3, wherein the revolution decelerating unit comprises:
a first driving module that includes a first driving shaft and a solar gear, wherein an end of the first driving shaft is integrally connected to a center of the solar gear;
a second driving module that includes a second driving shaft and a pinion, wherein an end of the second driving shaft is integrally connected to a center of the pinion;
a gear sequence which is identical in number to the solar gear and the pinion and is engaged with the solar gear and the pinion, wherein the gear sequence includes first and second gears and a support shaft that passes through central portions of the first and second gears; and
a support unit through which the first and second driving shafts rotatably pass, wherein the support shaft is rotatably supported by the support unit, wherein a through hole is formed to pass through the first driving shaft, the solar gear, the pinion, and the second driving shaft, wherein the main driving shaft passes through the through hole.

7. The system of claim 6, wherein a latch groove is provided at an outer circumferential portion of the main driving shaft and includes a sliding portion and an engaging portion, and wherein the revolution decelerating unit includes a latch module at an outer circumferential portion of the second driving shaft, wherein the latch module includes
a support frame that rotates together with the second driving shaft, a latch unit that is provided on an upper side of the support frame, and a latch casing that includes a spring therein to elastically and downwardly support the latch unit, wherein a lower portion of the latch unit has a shape corresponding to a shape of the latch groove, and wherein a latch move hole is formed at the second driving shaft, wherein the latch unit passes through the latch move hole to be guided to the latch groove.

8. The system of claim 6, wherein a one-way bearing is disposed on an outer circumferential portion of the first driving shaft of the revolution decelerating unit and rotates in a direction of the main driving shaft but not in an opposite direction, and wherein a first pulley is disposed on an outer circumferential portion of the one-way bearing and rotates together with the one-way bearing, and the first pulley is connected with a second pulley disposed on a driving shaft of the spring winding motor.

9. The system of claim 2, wherein each of the first revolution accelerating unit, the second revolution accelerating unit, and the third revolution accelerating unit comprises:
a first driving module that includes a first driving shaft and a solar gear, wherein an end of the first driving shaft is integrally connected to a center of the solar gear;
a second driving module that includes a second driving shaft and a pinion, wherein an end of the second driving shaft is integrally connected to a center of the pinion;
at least one gear sequence, wherein the number of gear sequences is as the same as the number of solar gears and pinions and wherein each gear sequence is engaged with the solar gear and the pinion, and includes first and second gears and a support shaft that passes through central portions of the first and second gears; and
a support unit through which the first and second driving shafts rotatably pass, wherein the support shaft is rotatably supported by the support unit, wherein a through hole is formed to pass through the first driving shaft, the solar gear, the pinion, and the second driving shaft, wherein a shaft passes through the through hole.

10. The system of claim 9, wherein a one-way bearing is disposed on an outer circumferential portion of the main driving shaft between the main driving shaft and a pulley and rotates in a direction of the main driving shaft but not in an opposite direction, and the pulley is disposed on an outer circumferential portion of the one-way bearing to rotate along with the one-way bearing.

11. The system of claim 1, wherein the detection sensor includes contact points which are spaced by a predetermined distance apart from an outermost side of a plate spring belonging to the spring and the outermost side, wherein the contact points are pressed to contact each other by the outermost side of the plate spring when the tension of the spring is less than the predetermined amount.

12. The system of claim 1, wherein the main driving shaft is equipped with a braking disk, wherein the braking unit exerts pressure on the braking disk.
